(19) United States
(12) Patent Application Publication
(10) Pub. No.: US 2016/0152833 A1
(43) Pub. Date: Jun. 2, 2016

(54) DIRECTION-INDEPENDENTLY IMPACT-RESISTANT 3-D MOLDED PARTS

(71) Applicant: COVESTRO DEUTSCHLAND AG, Leverkusen (DE)

(72) Inventors: Serguei KOSTROMINE, Swisttal-Buschhoven (DE); Joachim PETZOLDT, Monheim (DE); Wieland HOVESTADT, Leichlingen (DE); Sven HOBEIKA, Solingen (DE); Roland KÜNZEL, Leverkusen (DE)

(73) Assignee: Covestro Deutschland AG, Leverkusen (DE)

(21) Appl. No.: 14/897,734

(22) PCT Filed: Jun. 11, 2014
(86) PCT No.: PCT/EP2014/062082

§ 371 Date: Dec. 11, 2015

(30) Foreign Application Priority Data
Jun. 14, 2013 (EP) 13172190.4

(51) Int. Cl. C09D 4/06; B29C 67/00; B29C 41/20

(52) U.S. Cl. CPC C09D 4/06; B29C 41/20; B29C 67/0081; B33Y 10/00

(57) ABSTRACT

The present invention relates to a coating composition comprising at least 30% by weight of at least one thermoplastic polymer having a mean molar mass of at least 100 000 g/mol, at least one UV-curable reactive diluent, at least one photoinitiator, at least one organic solvent, where the proportion of ethylenically unsaturated groups is at least 3 mol per kg of the solids content of the coating composition. The present invention relates more particularly to a moulding comprising a thermoplastic polymer, a film of a thermoplastic polymer and a surface coating of the film, said surface coating forming the surface of the moulding and having a thickness in the range of ≧0.1 μm and ≦20 μm, obtainable by coating the film with the coating composition. In this way, a non-directionally impact-resistant moulding having a scratch-resistant and solvent-resistant surface is provided.

The present invention relates to non-directionally impact-resistant 3D polymer mouldings having a scratch-resistant and solvent-resistant surface, and to film insert moulding processes for production thereof.

Film insert moulding technology has become established for the production of plastics parts in the injection moulding process. It involves first two- or three-dimensionally prefabricating the frontal surface of a part from a coated film and then filling or insert moulding it with a polymer melt from the reverse side.

It is often desirable that the front side has sufficient protection from chemical and mechanical effects. This is often achieved in the prior art by an appropriate coating or paint film on the surface. In order to avoid wet coating of the finished three-dimensional parts, it is advantageous that such a paint film or coating should already have been applied to the film which then runs through all the further forming steps with the film and is then ultimately cured, for example by UV exposure.

This gives rise to a very specific profile of properties for coated films which suit this technology. In the prior art, the term “formable hardcoating” has become established for this product class, meaning a film coating which is at first sufficiently blocking-resistant, but then can be thermally formed as desired together with the substrate and at the end receives the properties of a protective layer through UV curing.

Such a combination of properties, in the sense of blocking resistance and thermoplastic characteristics of the primary coating, together with the great latent potential for UV crosslinking, is difficult to implement.

Most of the approaches to a solution for this objective in the prior art comprise the use of macromonomers which are prepared principally by dual-cure processes, as described inter alia in Beck, Erich (BASF), Scratch resistant UV coatings for automotive applications, Pitture e Vernici, European Coatings (2006), 82(9), 10-19; Beck, Erich, Into the third dimension: three ways to apply UV coating technology to 3D-automotive objects, European Coatings Journal (2006), (4), 32, 34, 36, 38-39; Petzoldt, Joachim; Coloma, Fermin (BMS), New three-dimensionally formable hardcoat films, JOT, Journal fuer Oberflaechentechnik (2010), 50(9), 40-42 EP 2113527 A1, Petzoldt et al., Development of new generation hardcoated films for complex 3D-shaped FIM applications, RadTech Asia 2011, Conference Proceedings.

Furthermore, plastics parts which find wide use in automobiles, in all other modes of transport, electrical and electronic devices, and in the construction industry are subject to high demands in relation to their toughness and impact resistance down to low use-relevant temperatures of down to −30° C. It is known that products made from polycarbonate, for example, have this property. However, polycarbonate surfaces also have a certain sensitivity to scratches and solvents. However, it is likewise known that brittle or less impact-resistant polymer layers applied to polycarbonate, for example coating materials to increase the scratch resistance or PMMA outer layers, adversely affect the impact resistance of polycarbonate. Plastics parts made from co-extruded PC/PMMA films therefore generally do not exhibit acceptable impact resistance, especially when the impact comes from the side of the polycarbonate, such that the polymethylmethacrylate is in the tensile zone of the impact.

There is therefore a considerable need for mouldings which are non-directionally impact-resistant even at low temperatures, are obtainable flexibly and efficiently by film insert moulding, and at the same time have a scratch-resistant and solvent-resistant surface.

The present invention therefore provides the following:

A non-directionally impact-resistant 3D moulding comprising a thermoplastic polymer, a film of a thermoplastic polymer and a scratch-resistant and solvent-resistant surface coating of the film, said surface coating forming the surface of the moulding and having a thickness in the range from ≧0.1 μm to ≦20 μm, obtainable by coating a surface of the film with a coating composition, comprising:
(a) at least one thermoplastic polymer having a mean molar mass of at least 100 000 g/mol in a content of 30% by weight of the solids content of the coating composition;
(b) at least 30% by weight of a UV-curable reactive diluent;
(c) 0.1 to 10 parts by weight of at least one photoinitiator; and
(d) at least one organic solvent,
   where the proportion of ethylenically unsaturated groups is at least 3 mol per kg of the solids content of the coating composition.

The inventive coating composition can be obtained in a simple and efficient manner. Furthermore, coatings obtainable thereby have sufficient blocking resistance on many surfaces such as, more particularly, the films considered for use in the film insert moulding process, but can then be thermally formed as desired together with the coated substrate and receive a scratch-resistant and solvent-resistant surface after curing, for example by UV radiation. Furthermore, it has been found that, surprisingly, non-directional impact resistance of the moulding is obtained especially when the surface coating of the film is in a thickness in the range from ≧0.1 μm to ≦20 μm.

A non-directional toughness sufficient for application purposes in the context of the present invention is understood to mean that the mouldings, in a puncture test based on DIN EN ISO 6603-1, at −30° C., exhibit toughness characteristics up to an impact speed of 2.5 m/s, preferably to 3.0 m/s, more preferably to 3.5 m/s, from both sides. “Toughness” in the context of the puncture test is defined by the nature of the fracture produced, namely by the distinction between ductile fractures and brittle fractures, as will be explained hereinafter: The puncture test based on DIN EN ISO 6603-1 is conducted with a falling mass of 13 kg, a sample size of 50×50 mm², a spike diameter of 20 mm and a round contact surface with hole diameter 40 mm, with variation of the impact speed to determine the ductile/brittle transition. The nature of the fracture (ductile/brittle fracture) can be determined on the basis of the appearance of the fracture in the impacted test specimens: A ductile fracture is considered to be either a plastic deformation without cracking (as per the standard) or (in a departure from the standard) a puncture of the specimen if it remains in one piece. Brittle fracture is regarded as the breakup of the sample into two or more pieces.

The scratch resistance can be determined using the pencil hardness, as measurable on the basis of ASTM D 3363. An assessment of solvent resistance can be made on the basis of EN ISO 2812-3:2007. It is remarkable that the surface of the moulding obtained by the inventive coating of the film with the coating composition and final curing by UV radiation has very good durability, even with respect to acetone, a solvent which is otherwise very harmful to polycarbonate surfaces.

It is especially preferable in this context that the inventive moulding is obtainable by means of film insert moulding, film insert moulding comprising the filling of a 3D-formed film comprising the protective layer with the melt of a thermoplastic polymer on the side of the film remote from the protective layer.

Film insert moulding in the context of the present invention is a process in which the film is coated with the coating composition, then the film is formed three-dimensionally, for example by thermal means, and then the film is reverse-coated or insert-moulded with the thermoplastic polymer on the side facing away from the film. This coating operation may already comprise a drying operation. Preferably, the reverse-coating operation is preceded by curing of the coating on the surface of the film by means of actinic radiation, preferably UV radiation.

Films used for coating are preferably transparent thermoplastics such as polycarbonate, polyacrylate or poly(meth)acrylate, polysulphones, polyesters, thermoplastic polyurethane and polystyrene, and the copolymers and mixtures (blends) thereof. Suitable thermoplastics are, for example, polyacrylates, poly(meth)acrylates (e.g. PMMA; e.g. Plexiglas® from Röhm), cycloolefin copolymers (COC; e.g. Topas® from Ticona; Zenoex® from Nippon Zeon or Apel® from Japan Synthetic Rubber), polysulphones (Ultrason@ from BASF or Udel® from Solvay), polyesters, for example PET or PEN, polycarbonate (PC), polycarbonate/polyester blends, e.g. PC/PET, polycarbonate/polycyclohexylmethanol cyclohexanedicarboxylate (PCCD; Xylecs® from GE), polycarbonate/PBT and mixtures thereof.

In a particularly advantageous and preferred embodiment, the film of the inventive moulding comprises polycarbonate or copolycarbonate.

Because of its excellent impact resistance with simultaneous transparency, polycarbonate is also used in the context of the present invention as a thermoplastic polymer for insert moulding or filling of the 3D-formed film coated with the protective layer. In a likewise preferred embodiment of the present invention, the thermoplastic polymer thus comprises polycarbonate. Polycarbonates and polycarbonate formulations, and also polycarbonate films, suitable for the invention are obtainable, for example, under the Makrolon®, Bayblend® and Makroblend® trade names (Bayer MaterialScience AG).

Suitable polycarbonates for the production of the inventive polycarbonate compositions are all the known polycarbonates. These are homopolycarbonates, copolycarbonates and thermoplastic polyester carbonates. The suitable polycarbonates preferably have mean molecular weights M̅_{w} of 18 000 to 40 000, preferably of 26 000 to 36 000 and especially of 28 000 to 35 000, determined by measuring the relative solution viscosity in dichloromethane or in mixtures of equal weights of phenol/o-dichlorobenzene, calibrated by light scattering.

The polycarbonates are preferably prepared by the interfacial process or the melt transesterification process, which have been described many times in the literature. With regard to the interfacial process, reference is made by way of example to H. Schnell, Chemistry and Physics of Polycarbonates, Polymer Reviews, vol. 9, Interscience Publishers, New York 1964 P. 33 ff., to Polymer Reviews, vol. 10, “Condensation Polymers by Interfacial and Solution Methods”, Paul W. Morgan, Interscience Publishers, New York 1965, ch. VIII, p. 325, to Drs. U. Grigo, K. Kircher and P. R-Müller “Polycarbonate” [Polycarbonates] in Becker/Braun, Kunststoff-Handbuch [Polymer Handbook], volume 3/1, Polycarbonate, Polyacetale, Polyester, Celluloseester [Polycarbonates, Polyacetals, Polyesters, Cellulose Esters], Carl Hanser Publishers, Munich, Vienna, 1992, p. 118-145, and to EP-A 0 517 044. The melt transesterification process is described, for example, in Encyclopedia of Polymer Science, vol. 10 (1969), Chemistry and Physics of Polycarbonates, Polymer Reviews, H. Schnell, vol. 9, John Wiley and Sons, Inc. (1964), and in patent specifications DE-B 10 31 512 and U.S. Pat. No. 6,228,973.

The polycarbonates can be obtained from reactions of bisphenol compounds with carbonic acid compounds, especially phosgene, or diphenyl carbonate or dimethyl carbonate in the melt transesterification process. Particular preference is given here to homopolycarbonates based on bisphenol A and copolycarbonates based on monomers bisphenol A and 1,1-bis(4-hydroxyphenyl)-3,3,5-trimethylcyclohexane. Further bisphenol compounds which can be used for the polycarbonate synthesis are disclosed, inter alia, in WO-A 2008037364, EP-A 1 582 49, WO-A 2002026862, WO-A 2005113639.

The polycarbonates may be linear or branched. It is also possible to use mixtures of branched and unbranched polycarbonates.

Suitable branching agents for polycarbonates are known from the literature and are described, for example, in patent specifications U.S. Pat. No. 4,185,009, DE-A 25 00 092, DE-A 42 40 313, DE-A 19 943 642, U.S. Pat. No. 5,367,044 and in literature cited therein. Furthermore, the polycarbonates used may also be intrinsically branched, in which case no branching agent is added in the course of polycarbonate preparation. One example of intrinsic branches is that of so-called Fries structures, as disclosed for melt polycarbonates in EP-A 1 506 249.

In addition, it is possible to use chain terminators in the polycarbonate preparation. The chain terminators used are preferably phenols such as phenol, alkylphenols such as cresol and 4-tert-butylphenol, chlorophenol, bromophenol, cumylphenol or mixtures thereof.

The polymer composition(s) of the film or of the thermoplastic polymer of the 3D moulding may additionally comprise additives, for example UV absorbers, IR absorbers and other customary processing aids, especially demoulding agents and fluxes, and also the customary stabilizers, especially thermal stabilizers, and also antistats, pigments, colourants and optical brighteners. In every layer, different additives or concentrations of additives may be present.

The coating composition forms a further part of the subject-matter of the present invention. It comprises (a) at least one thermoplastic polymer having a mean molar mass of at least 100 000 g/mol in a content of 30% by weight of the solids content of the coating composition; (b) at least 30% by weight of a UV-curable reactive diluent; (c) ≧0.1 to ≦10 parts by weight of at least one photoinitiator, and (d) at least one organic solvent, where the proportion of ethylenically unsaturated groups is at least 3 mol per kg of the solids content of the coating composition.

Thermoplastic polymers are understood to mean polymethylmethacrylate (PMMA), various kinds of polyester (e.g. PET, PEN, PBTP and UP), other polymers such as rigid PVC, cellulose esters (such as CA, CAB, CP), polystyrene (PS) and copolymers (SAN, SB and MBS), polyacrylonitrile (PAN), ABS polymers, acrylonitrile-methyl methacrylate (AMMA), acrylonitrile-styrene-acrylic ester (ASA), polyurethane (PUR), polyethylene (PE, PE-HD, -LD, -LLD, -C), polypropylene (PP), polyamide (PA), polycarbonate (PC) or polyether sulphone (PES)/(abbreviations to DIN 7728T1).

It has been found that thermoplastic polymers having a molecular weight Mw of at least 100 000 g/mol contribute in a particularly advantageous manner to adequate blocking resistance of the dried coating on the one hand, and on the other hand to the scratch resistance and solvent resistance of the inventive surface coating cured by UV radiation, for example. Further preferred thermoplastic polymers are those having a molecular weight Mw of at least 150 000 g/mol, more preferably having a molecular weight Mw of at least 200 000 g/mol. More particularly, linear thermoplastic polymers which fulfil the above conditions are preferred.

The Vicat softening temperatures VET (ISO 306) are preferably in the region of at least 90° C., advantageously at least 95° C., particularly advantageously at least 100° C.

An advantageous and therefore particularly preferred thermoplastic polymer is polymethylmethacrylate.

Polymethylmethacrylate (PMMA) is understood to mean polymethylmethacrylate homopolymer and methyl methacrylate-based copolymers having a methyl methacrylate content of more than 70% by weight, as known, for example, by the trade names Degalan®, Degacryl®, Plexyglas®, Acrylite® (from Evonik), Altuglas, Oroglas (from Arkema), Elvacite®, Colacryl®, Lucite® (from Lucite), and under names including Acrylglas, Conacryl, Deglas, Diakon, Friacryl, Hesaglas, Limacryl, PerClax and Vitroflex.

Preference is given to PMMA homopolymers and copolymers of 70% by weight to 99.5% by weight of methyl methacrylate and 0.5% by weight to 30% by weight of methyl acrylate. Particular preference is given to PMMA homopolymers and copolymers of 90% by weight to 99.5% by weight of methyl methacrylate and 0.5% by weight to 10% by weight of methyl acrylate. In a preferred embodiment, the Vicat softening temperatures VET (ISO 306) are in the region of at least 90° C., preferably from 100° C. to 115° C.

It has been found that especially PMMA homopolymers and copolymers having a molecular weight Mw of at least 100 000 g/mol contribute in a particularly advantageous manner to the scratch resistance and solvent resistance of the inventive surface coating.

Particular preference is therefore given to PMMA homopolymers and copolymers having a molecular weight Mw of at least 100 000 g/mol, more preferably having a molecular weight Mw of at least 150 000 g/mol, most preferably having a molecular weight Mw of at least 200 000 g/mol.

The molecular weight Mw can be determined, for example, by gel permeation chromatography or by the scattered light method (see, for example, H. F. Mark et al., Encyclopedia of Polymer Science and Engineering, 2nd edition, vol. 10, pages 1 ff., J. Wiley, 1989).

The proportion of the thermoplastic polymer in the solids content of the coating composition is at least 30% by weight, more preferably at least 40% by weight and most preferably 45% by weight.

Reactive diluents usable with preference as component (b) of the inventive coating composition are bifunctional, trifunctional, tetrafunctional, pentafunctional or hexafunctional acrylic and/or methacrylic monomers. Preference is given to ester functions, especially acrylic ester functions. Suitable polyfunctional acrylic acid and/or methacrylic esters derive from aliphatic polyhydroxyl compounds having at least 2, preferably at least 3 and more preferably at least 4 hydroxyl groups, and preferably 2 to 12 carbon atoms.

Examples of such aliphatic polyhydroxyl compounds are ethylene glycol, propylene glycol, butane-1,4-diol, hexane-1,6-diol, diethylene glycol, triethylene glycol, glycerol, trimethylolpropane, pentaerythritol, dipcntaerythritol, tetramethylolethane and sorbitan. Examples of esters suitable with preference in accordance with the invention as reactive diluents are glycol diacrylate and dimethacrylate, butanediol diacrylate or dimethacrylate, dimethylolpropane diacrylate or dimethacrylate, diethylene glycol diacrylate or dimethacrylate, divinylbenzene, trimethylolpropane triacrylate or trimethacrylate, glyceryl triacrylate or trimethacrylate, pentaerythrityl tetraacrylate or tetramethacrylate, dipentaerythrityl penta-/hexaacrylate (DPHA), butane-1,2,3,4-tetrayl tetraacrylate or tetramethacrylate, tetramethylolethane tetraacrylate or tetramethacrylate, 2,2-dihydroxypropane-1,3-diol tetraacrylate or tetramethacrylate, diurethane dimethacrylate (UDMA), sorbitan tetra-, penta- or hexaacrylate or the corresponding methacrylates. It is also possible to use mixtures of crosslinking monomers having two to four or more ethylenically unsaturated, free-radically polymerizable groups.

Additionally in accordance with the invention, it is possible to use, as reactive diluents or components b) of the inventive coating composition, alkoxylated di-, tri-, tetra-, penta- and hexaacrylates or -methacrylates. Examples of alkoxylated diacrylates or -methacrylates are alkoxylated, preferably ethoxylated, methanediol diacrylate, methanediol dimethacrylate, glyceryl diacrylate, glyceryl dimethacrylate, neopentyl glycol diacrylate, neopentyl glycol dimethacrylate, 2-butyl-2-ethylpropane-1,3-diol diacrylate, 2-butyl-2-ethylpropane-1,3-diol dimethacrylate, trimethylolpropane diacrylate or trimethylolpropane dimethacrylate.

Examples of alkoxylated triacrylates or -methacrylates are alkoxylated, preferably ethoxylated, pentaerythrityl triacrylate, pentaerythrityl trimethacrylate, glyceryl triacrylate, glyceryl trimethacrylate, butane-1,2,4-triol triacrylate, butane-1,2,4-triol trimethacrylate, trimethylolpropane triacrylate, trimethylolpropane trimethacrylate, tricyclodecanedimethanol diacrylate, tricyclodecanedimethanol dimethacrylate, ditrimethylolpropane tetraacrylate or ditrimethylolpropane tetramethacrylate. Examples of alkoxylated tetra-, penta- or hexaacrylates are alkoxylated, preferably ethoxylated, pentaerythrityl tetraacrylate, dipentaerythrityl tetraacrylate, dipentaerythrityl pentaacrylate, dipentaerythrityl hexaacrylate, pentaerythrityl tetramethacrylate, dipentaerythrityl tetramethacrylate, dipentaerythrityl pentamethacrylate or dipentaerythrityl hexamethacrylate. In the alkoxylated diacrylates or -methacrylates, triacrylates or -methacrylates, tetraacrylates or -methacrylates, pentaacrylates or -methacrylates and/or alkoxylated hexaacrylates or -methacrylates in component b), all the acrylate groups or methacrylate groups or only some of the acrylate groups or methacrylate groups in the respective monomer may be bonded to the corresponding radical via alkylene oxide groups. It is also possible to use any desired mixtures of such wholly or partly alkoxylated di-, tri-, tetra-, penta- or hexaacrylates or -methacrylates. In this case, it is also possible that the acrylate or methacrylate group(s) is/are bonded to the aliphatic, cycloaliphatic or aromatic radical of the monomer via a plurality of successive alkylene oxide groups, preferably ethylene oxide groups. The mean number of alkylene oxide or ethylene oxide groups in the monomer is stated by the alkoxylation level or ethoxylation level. The alkoxylation level or ethoxylation level may preferably be from 2 to 25, particular preference being given to alkoxylation levels or ethoxylation levels of 2 to 15, most preferably of 3 to 9.

Likewise in accordance with the invention, reactive diluents or components b) of the inventive coating composition may be oligomers which belong to the class of the aliphatic urethane acrylates or of the polyester acrylates or polyacryloylacrylates. The use thereof as paint binders is known and is described in Chemistry & Technology of UV & EB Formulation for Coatings, Inks & Paints, vol. 2, 1991, SITA Technology, London (P. K. T. Oldring (ed.) on p. 73-123 (Urethane Acrylates) and p. 123-135 (Polyester Acrylates). Commercially available examples which are suitable within the inventive context include aliphatic urethane acrylates such as Ebecryl® 4858, Ebecryl® 284, Ebecryl® 265, Ebecryl® 264, Ebecryl® 8465, Ebecryl® 8402 (each manufactured by Cytec Surface Specialities), Craynor® 925 from Cray Valley, Viaktin® 6160 from Vianova Resin, Desmolux VP LS 2265 from Bayer MaterialScience AG, Photomer 6891 from Cognis, or else aliphatic urethane acrylates dissolved in reactive diluents, such as Laromer® 8987 (70% in hexanediol diacrylate) from BASF AG, Desmolux U 680 H (80% in hexanediol diacrylate) from Bayer MaterialScience AG, Craynor® 945B85 (85% in hexanediol diacrylate), Ebecryl® 294/25HD (75% in hexanediol diacrylate), Ebecryl® 8405 (80% in hexanediol diacrylate), Ebecryl® 4820 (65% in hexanediol diacrylate) (each manufactured by Cytec Surface Specialities) and Craynor® 963B80 (80% in hexanediol diacrylate), each from Cray Valley, or else polyester acrylates such as Ebecryl® 810, 830, or polyacryloylacrylates such as Ebecryl®, 740, 745, 767 or 1200 from Cytec Surface Specialities.

In a further preferred embodiment, the reactive diluent (b) comprises alkoxylated diacrylates and/or dimethacrylates, alkoxylated triacrylates and/or trimethacrylates, alkoxylated tetraacrylates and/or tetramethacrylates, alkoxylated pentaacrylates and/or pentamethacrylates, alkoxylated hexaacrylates and/or hexamethacrylates, aliphatic urethane acrylates, polyester acrylates, polyacryloylacrylates and mixtures thereof.

Also in accordance with the invention are mixtures of such crosslinking multifunctional monomers and monofunctional monomers, for example methyl methacrylate. The proportion of the multifunctional monomers in such a mixture is preferably at least 20% by weight.

In a further preferred embodiment, the reactive diluent (b) of the inventive coating composition comprises dipentaerythrityl penta-/hexaacrylate.

The reactive diluent is an essential part of the inventive coating composition and of the inventive coating. The total proportion of the reactive diluent in the solids content of the coating composition is preferably at least 30% by weight, more preferably at least 40% by weight and most preferably at least 45% by weight.

The content of ethylenically unsaturated groups has a significant influence on the achievable durability properties of the radiation-cured coating. Therefore, the inventive coating composition contains a content of ethylenically unsaturated groups of at least 3.0 mol per kg of solids content of the coating composition, preferably at least 3.5 mol per kg, more preferably at least 4.0 mol per kg of solids content of the coating composition.

The term “at least one photoinitiator” in the inventive coating composition encompasses the standard, commercially available compounds known to those skilled in the art, for example a-hydroxyketones, benzophenone, α,α-diethoxyacetophenone, 4,4-diethylaminobenzophenone, 2,2-dimethoxy-2-phenylacetophenone, 4-isopropylphenyl 2-hydroxy-2-propyl ketone, 1-hydroxycyclohexyl phenyl ketone, isoamyl p-dimethylaminobenzoate, methyl 4-dimethylaminobenzoate, methyl o-benzoylbenzoate, benzoin, benzoin ethyl ether, benzoin isopropyl ether, benzoin isobutyl ether, 2-hydroxy-2-methyl-1-phenylpropan-1-one, 2-isopropylthioxanthone, dibenzosuberone, 2,4,6-trimethylbenzoyldiphenylphosphine oxide, bisacylphosphine oxide and others, said photoinitiators being utilizable alone or in combination of two or more or in combination with one of the above polymerization initiators.

UV photoinitiators used are, for example, the IRGACURE® products from BASF, for example the products IRGACURE® 184, IRGACURE® 500, IRGACURE® 1173, IRGACURE®2959, IRGACURE® 745, IRGACURE® 651, IRGACURE® 369, IRGACURE® 907, IRGACURE® 1000, IRGACURE® 1300, IRGACURE® 819, IRGACURE® 819DW, IRGACURE® 2022, IRGACURE® 2100, IRGACURE® 784, IRGACURE® 250; in addition, the DAROCUR® products from BASF are used, for example the products DAROCUR® MBF, DAROCUR® 1173, DAROCUR® TPO, DAROCUR® 4265. Among other substances, the further UV photoinitiators are used, for example Esacure One (from Lamberti).

Photoinitiators are present in the coating composition at in the range from ≧0.1 to ≦10 parts by weight of the solids content of the coating composition.

The coating composition additionally contains, over and above the 100 parts by weight of components 1) to 3), one or more organic solvents. Such organic solvents may be selected, for example, from the group comprising aromatic solvents, for example xylene or toluene, ketones, for example acetone, 2-butanone, methyl isobutyl ketone, diacetone alcohol, alcohols, for example methanol, ethanol, i-propanol, butanol, l-methoxy-2-propanol, ethers, for example 1,4-dioxane, ethylene glycol n-propyl ether, or esters, for example ethyl acetate, butyl acetate, 1-methoxy-2-propyl acetate, or mixtures comprising these solvents.

Preference is given to ethanol, i-propanol, butanol, ethyl acetate, butyl acetate, 2-methoxypropyl alcohol, diacetone alcohol, xylene or toluene. Particular preference is given to i-propanol, butanol, ethyl acetate, butyl acetate, 1-methoxy-2-propanol, diacetone alcohol and mixtures thereof. Very particular preference is given to 1-methoxy-2-propanol and diacetone alcohol; 1-methoxy-2-propanol is especially preferred.

The coating material composition preferably contains, in addition to the 100 parts by weight of components 1) to 3), 0 to 900 parts by weight, more preferably 100 to 850 parts by weight, most preferably 200 to 800 parts by weight, of at least one organic solvent (component 4).

The coating composition may additionally optionally contain, over and above the 100 parts by weight of components 1) to 3), one or more further coatings additives. Such coatings additives may be selected, for example, from the group comprising stabilizers, levelling agents, surface additives, pigments, dyes, inorganic nanoparticles, adhesion promoters, UV absorbers, IR absorbers, preferably from the group comprising stabilizers, levelling agents, surface additives and inorganic nanoparticles. The coating material composition preferably contains, in addition to the 100 parts by weight of components 1) to 3), 0 to 35 parts by weight, more preferably 0 to 30 parts by weight, most preferably 0.1 to 20 parts by weight, of at least one further coatings additive. Preferably, the total proportion of all the coatings additives present in the coating material composition is 0 to 20 parts by weight, more preferably 0 to 10 parts by weight, most preferably 0.1 to 10 parts by weight.

The composition of the coating composition may comprise inorganic nanoparticles to increase the mechanical durability, for example scratch resistance and/or pencil hardness.

Useful nanoparticles include inorganic oxides, mixed oxides, hydroxides, sulphates, carbonates, carbides, borides and nitrides of elements of main group II to IV and/or elements of transition group I to VIII of the Periodic Table, including the lanthanides. Preferred nanoparticles are silicon oxide, aluminium oxide, cerium oxide, zirconium oxide, niobium oxide, zinc oxide or titanium oxide nanoparticles, particular preference being given to silicon oxide nanoparticles.

The particles used preferably have mean particle sizes (measured by means of dynamic light scattering in dispersion, determined as the Z-average) of less than 200 nm, preferably of 5 to 100 nm, more preferably 5 to 50 nm. Preferably at least 75%, more preferably at least 90%, even more preferably at least 95%, of all the nanoparticles used have the sizes defined above.

The coating composition can be produced in a simple manner by first of all dissolving the polymer completely in the solvent at room temperature or at elevated temperatures and then the other obligatory and any optional components to the solution which has been cooled to room temperature, either combining them in the absence of solvent(s) and mixing them together by stirring, or in the presence of solvent(s), for example adding them to the solvent(s), and mixing them together by stirring. Preferably, first the photoinitiator is dissolved in the solvent(s) and then the further components are added. This is optionally followed by a purification by means of filtration, preferably by means of fine filtration.

In a very particularly preferred embodiment of the present invention, the coating composition according to the present invention comprises (a) at least 30% by weight in the solids content of the coating composition of at least one thermoplastic polymer having a mean molar mass Mw of at least 100 000 g/mol, preferably at least 150 000 g/mol, more preferably at least 200 000 g/mol, and a Vicat softening temperature VET to ISO 306 of at least 90° C., preferably at least in the range from 100 to 115° C., (b) at least 30% by weight, preferably at least 40% by weight, more preferably at least 45% by weight, in the solids content of the coating composition, of at least one UV-curable reactive diluent, (c) 0.1 to 10 parts by weight of the coating composition of at least one photoinitiator and (d) at least one organic solvent, preferably 1-methoxy-2-propanol.

Preferably, the mouldings of the present invention are obtainable by a film insert moulding process. The present invention therefore further provides a film insert moulding process for producing a moulding, comprising the steps of
(i) coating a surface of a film with a moulding composition comprising
   (a) at least one thermoplastic polymer having a mean molar mass of at least 100 000 g/mol in a content of 30% by weight of the solids content of the coating composition;
   (b) at least 30% by weight of a UV-curable reactive diluent;
   (c) 0.1 to 10 parts by weight of at least one photoinitiator; and
   (d) at least one organic solvent,
   where the proportion of ethylenically unsaturated groups is at least 3 mol per kg of the solids content of the coating composition and the thickness of the coating is in the range from ≧0.1 μm to ≦20 μm,
(ii) drying the coating;
(iii) optionally cutting the film to size and/or delaminating, printing and/or thermally or mechanically forming the film;
(iv) curing the coating by means of actinic radiation, preferably UV radiation;
(v) insert-moulding the uncoated surface of the film with a thermoplastic polymer.

The film can be coated with the coating composition by the standard methods for coating films with fluid coating compositions, for example by knife-coating, spraying, pouring, flow-coating, dipping, rolling or spin-coating. The flow-coating process can be effected manually with a hose or suitable coating head, or automatically in a continuous run by means of flow-coating robots and optionally slot dies. Preference is given to the application of the coating composition by a roll-to-roll transfer. In this case, the surface of the film to be coated may be pretreated by cleaning or activation.

The drying follows the application of the coating composition to the film. For this purpose, more particularly, elevated temperatures in ovens, and moving and optionally also dried air, for example in convection ovens or by means of nozzle dryers, and thermal radiation such as IR and/or NIR, are employed. In addition, it is possible to use microwaves. It is possible and advantageous to combine a plurality of these drying processes. The drying of the coating in step (II) preferably comprises flash-off at room temperature and/or elevated temperature, such as preferably at 20-200° C., more preferably at 40-120° C. After the coating has been dried, it is blocking-resistant, and so the coated substrate, especially the coated film, can be laminated, printed and/or thermally formed. Forming in particular is preferred in this context, since merely the forming of a coated film here can define the mould for a film insert moulding process for production of a three-dimensional plastics part.

Advantageously, the conditions for the drying are selected such that the elevated temperature and/or the thermal radiation does not trigger any polymerization (crosslinking) of the acrylate or methacrylate groups, since this can impair formability. In addition, the maximum temperature attained should appropriately be selected at a sufficiently low level that the film does not deform in an uncontrolled manner.

After the drying/curing step, the coated film, optionally after lamination with a protective film on the coating, can be rolled up. The film can be rolled up without the coating sticking to the reverse side of the substrate film or of the laminating film. However, it is also possible to cut the coated film to size and to send the cut sections individually or as a stack to further processing.

Curing with actinic radiation is understood to mean the free-radical polymerization of ethylenically unsaturated carbon-carbon double bonds by means of initiator radicals which are released, for example, from the above-described photoinitiators through irradiation with actinic radiation.

The radiative curing is preferably effected by the action of high-energy radiation, i.e. UV radiation or daylight, for example light of wavelength≧200 nm to ≦750 nm, or by irradiation with high-energy electrons (electron beams, for example ≧90 keV to ≦300 keV). The radiation sources used for light or UV light are, for example, moderate- or high-pressure mercury vapour lamps, wherein the mercury vapour may be modified by doping with other elements such as gallium or iron. Lasers, pulsed lamps (known by the name UV flashlight emitters), halogen lamps or excimer emitters are likewise usable. The emitters may be installed at a fixed location, such that the material to be irradiated is moved past the radiation source by means of a mechanical device, or the emitters may be mobile, and the material to be irradiated does not change position in the course of curing. The radiation dose typically sufficient for crosslinking in the case of UV curing is in the range from ≧80 mJ/cm² to ≦5000 mJ/cm².

In a preferred embodiment, the actinic radiation is therefore light in the UV light range.

The radiation can optionally be performed with exclusion of oxygen, for example under inert gas atmosphere or reduced-oxygen atmosphere. Suitable inert gases are preferably nitrogen, carbon dioxide, noble gases or combustion gases. In addition, the radiation can be effected by covering the coating with media transparent to the radiation. Examples thereof are polymer films, glass or liquids such as water.

According to the radiation dose and curing conditions, the type and concentration of any initiator used can be varied or optimized in a manner known to those skilled in the art or by exploratory preliminary tests. For curing of the formed films, it is particularly advantageous to conduct the curing with several emitters, the arrangement of which should be selected such that every point on the coating receives substantially the optimal radiation dose and intensity for curing. More particularly, unirradiated regions (shadow zones) should be avoided.

In addition, according to the film used, it may be advantageous to select the irradiation conditions such that the thermal stress on the film does not become too great. In particular, thin films and films made from materials having a low glass transition temperature can have a tendency to uncontrolled deformation when a particular temperature is exceeded as a result of the irradiation. In these cases, it is advantageous to allow a minimum level of infrared radiation to act on the substrate, by means of suitable filters or a suitable design of the emitters. In addition, reduction of the corresponding radiation dose can counteract uncontrolled deformation. However, it should be noted that a particular dose and intensity in the irradiation are needed for maximum polymerization. It is particularly advantageous in these cases to conduct curing under inert or reduced-oxygen conditions, since the required dose for curing decreases when the oxygen content is reduced in the atmosphere above the coating.

Particular preference is given to using mercury emitters in fixed installations for curing. In that case, photoinitiators are used in concentrations of ≧0.1% by weight to ≦10% by weight, more preferably of ≧0.2% by weight to ≦3.0% by weight, based on the solids content of the coating. These coatings are preferably cured using a dose of ≧80 mJ/cm² to ≦5000 mJ/cm².

The insert moulding of the coated film on completion of curing of the film coating and the optional, usually intended, forming of the coated film is well known to the person skilled in the art in the form of the film insert moulding process as described, for example, in WO 2004/082926 A1 and WO 02/07947 A1. In a preferred embodiment of the process according to the invention, the reverse coating of the film in step (V) is effected by means of extrusion or injection moulding, preferably with polycarbonate melt. The processes of extrusion and of injection moulding for this purpose are well known to those skilled in the art and are described, for example, in “Handbuch Spritzgieβen” [Injection Moulding Handbook], Friedrich Johannnaber/Walter Michaeli, Munich; Vienna: Hanser, 2001, ISBN 3-446-15632-1 or “Anleitung zum Bau von Spritzgieβwerkzeugen” [Introduction to the Construction of Injection Moulds], Menges/Michaeli/Mohren, Munich; Vienna: Hanser, 1999, ISBN 3-446-21258-2.

Because of the particularly advantageous combination of properties of non-directional impact resistance, even at low temperatures, and of scratch-resistant and solvent-resistant surface, the inventive 3D mouldings are suitable for use in products in the sectors of architecture, automobile construction, rail vehicle construction, aircraft construction, the manufacture of visors for protective helmets, and the production of electronic products. The present invention therefore further provides a product comprising the inventive 3D moulding. The product is preferably a transparent glazing element, cover or viewing window from the fields of architecture, automobile construction, rail vehicle construction, aircraft construction, the manufacture of visors for protective helmets and the production of electronic products, or a transparent or else nontransparent part of interior trim or exterior trim of automobiles, for example a dashboard, a column cover, a sunroof or a bumper.

The present invention further provides for the use of the inventive 3D moulding as an architectural glazing element, automobile glazing element, rail vehicle glazing element, water vehicle glazing element, aircraft glazing element, bodywork facing component, windshield, helmet visor, electronics housing component, or interior trim component of automobiles, rail vehicles, water vehicles or aircraft.

### EXAMPLES

### Assessment Methods

The layer thickness of the coatings was measured by observing the cutting-edge in an Axioplan optical microscope manufactured by Zeiss. Method—reflected light, bright field, magnification 500×.

Assessment of Blocking Resistance

Conventional test methods as described, for instance, in DIN 51350 are insufficient to simulate the blocking resistance of rolled-up, pre-dried, coated films, and therefore the following test was employed: The coating materials were applied to Makrofol DE 1-1 (375 μm) with a conventional coating bar (target wet film thickness 100 μm). After a flash-off phase at 20° C. to 25° C. for 10 min, the coated films were dried in an air circulation oven at 110° C. for 10 min. After a cooling phase of 1 min, a commercial GH-X173 natur pressure-sensitive lamination film (from Bischof und Klein, Lengerich, Germany) was applied without creasing to the dried coated film with a plastic roller over an area of 100 mm×100 mm. Subsequently, the laminated film piece was subjected to a weight of 10 kg over the full area for 1 hour. Thereafter, the lamination film was removed and the coated surface was assessed visually.

Assessment of Pencil Hardness

The pencil hardness was measured analogously to ASTM D 3363 using an Elcometer 3086 Scratch boy (Elcometer Instruments GmbH, Aalen, Germany) under a load of 500 g, unless stated otherwise.

Assessment of Steel Wool Scratching

The steel wool scratching is determined by sticking a piece of No. 00 steel wool (Oskar Weil GmbH Rakso, Lahr, Germany) onto the flat end of a 500 g fitter's hammer, the area of the hammer being 2.5 cm×2.5 cm, i.e. approximately 6.25 cm². The hammer is placed onto the surface to be tested without applying additional pressure, such that a defined load of about 560 g is attained. The hammer is then moved back and forth 10 times in twin strokes. Subsequently, the stressed surface is cleaned with a soft cloth to remove fabric residues and coating material particles. The scratching is characterized by haze and gloss values, measured transverse to the scratching direction, with a Micro HAZE plus (20° gloss and haze; Byk-Gardner GmbH, Geretsried, Germany). The measurement is effected before and after scratching. The differential values for gloss and haze before and after stress are reported as Δgloss and Δhaze.

Assessment of Solvent Resistance

The solvent resistance of the coatings was typically tested with isopropanol, xylene, 1-methoxy-2-propyl acetate, ethyl acetate, acetone, in technical-grade quality. The solvents were applied to the coating with a soaked cotton bud and protected from vaporization by covering. Unless stated otherwise, a contact time of 60 minutes at about 23° C. was observed. After the end of the contact time, the cotton bud is removed and the test surface is wiped clean with a soft cloth. The inspection is immediately effected visually and after gentle scratching with a fingernail.

A distinction is made between the following levels:
0=unchanged; no change visible; cannot be damaged by scratching.
1=slight swelling visible, but cannot be damaged by scratching.
2=change clearly visible, can barely be damaged by scratching.
3=noticeable change, surface destroyed after firm fingernail pressure.
4=significant change, scratched through to the substrate after firm fingernail pressure.
5=destroyed; the coating is already destroyed when the chemical is wiped away; the test substance cannot be removed (has eaten into the surface).

Within this assessment, the test is typically passed with the ratings of 0 and 1. Ratings of >1 represent a “fail”.

Assessment of Impact Resistance

The assessment of toughness was made using a drop test based on the standard DIN EN ISO 6603-1. Analogously to the standard, a puncture test is conducted here with varied drop energy, this being accomplished by variation of the drop height with constant falling mass. As a measure of the drop energy, the impact speed is measured directly by means of a light beam and reported as a variation parameter.

In a departure from the standard, a combination of contact surface diameter and spike diameter of 40 mm and 20 mm respectively, and a sample size of 50 mm×50 mm is used. The falling mass was 13 kg; the test temperature was −30° C.

The toughness was characterized by utilizing the fact that polymeric materials exhibit a transition from ductile to brittle fracture characteristics on variation of particular parameters (e.g. temperature, deformation rate, notch radius or the like). In the present case, the impact speed of the spike on the top side of the sample was used as the variable parameter.

As a value characteristic of the toughness, a “critical impact speed” was defined, which represents itself from the geometric mean of greatest speed with ductile fracture characteristics and lowest speed with brittle fracture characteristics:

v_{crit}=0.5[max(v_{ductile})+min(v_{brittle})]

To determine this toughness characteristic, the critical impact speed was varied within a suitable range and the fracture characteristics (ductile/brittle) for a selected speed were determined. The nature of the fracture (ductile/brittle fracture) was determined on the basis of the appearance of the fracture in the impacted test specimens: A ductile fracture is considered to be either a plastic deformation without cracking (as per the standard) or (in a departure from the standard) a puncture of the specimen if it remains in one piece—brittle fracture is regarded as the breakup of the sample into two or more pieces.

The critical impact speeds measured are between 2-2.5 m/s and 13 m/s. Samples which exhibit brittle fracture even at minimum impact speed are generally assessed as brittle; the critical impact speed is reported as “<2.0 m/s”.

Any multi-ply structure is thus characterized by the critical impact speed and can thus be compared with other systems and assessed.

Naturally, the thickness of the test specimens influences the deformation and fracture characteristics under mechanical stress. More particularly, the absolute measurements (maximum force, elongation at break) show a dependence on the sample thickness and cannot be compared directly with one another for test specimens of different thickness. Therefore, in the context of the present invention, samples of thickness 4 mm were used, the characteristics of which can be compared to one another, and the thickness of which is in a size typical of many applications.

Relative differences in the toughness of the various systems in the form of the position of the ductile/brittle transition or of the critical impact speeds—can, however, also be applied to other sample thicknesses. The relative density differences between the various coating material systems and structures, determined here by way of example on test specimens of thickness 4 mm, therefore also apply to samples having greater or lesser thicknesses.

The expression “tensile zone” in this context means the sample side which is opposite the impactor and therefore is subjected to tensile stress in the puncture test. In contrast, “pressure zone” denotes the sample region under the impactor on the impact side, where the stress is for the most part compressive.

### Example 1

### Production of a Coating Composition

25 g of Degacryl MW730 (PMMA, Evonik; M_{w} 1 000 000—Evonik figure) were dissolved in 142 g of 1-methoxy-2-propanol at 100° C. within about 5 h. The solution was cooled down to about 30° C. Separately, the following components were dissolved in 83 g of 1-methoxy-2-propanol at room temperature: 25 g of dipentaerythrityl penta-/hexaacrylate (DPHA, from Cytec), 2.0 g of Irgacure 1000 (from BASF), 1.0 g of Darocur 4265 (from BASF), 0.0625 g of BYK 333 (from BYK). The second solution was added to the polymer solution while stirring. The coating composition was stirred at room temperature and with shielding from direct influence of light for another 3 h, dispensed and then left to stand for 1 day. The yield was 250 g, the viscosity (23° C.) was about 9000 mPas and the solids content was 19% by weight. The double bond density in the solids content of the coating composition was calculated as about 5.1 mmol/kg.

### Example 2

### Production of a Coating Composition

Analogously to Example 1, Degalan M345 (PMMA; from Evonik; M_{w} 180 000) was used to produce a coating composition. The yield was 275 g, the solids content 19% by weight. The double bond density in the solids content of the coating composition was calculated as about 5.1 mmol/kg.

### COMPARATIVE EXAMPLE 1

### Production of a Comparative Coating Composition

Analogously to Example 1, Degalan M825 (PMMA; from Evonik; M_{w} 80 000) was used to produce a coating composition. The yield was 280 g, the solids content 19% by weight. The double bond density in the solids content of the coating composition was calculated as about 5.1 mmol/kg.

### Example 3

The coating compositions of Examples 1 and 2 and of Comparative Example 1 are applied to a Makrofol DE 1-1 backing film (Bayer MaterialScience AG, Leverkusen, Germany), in each case by means of a slot coater from “TSE Troller AG”. The layer thickness of the carrier film was 250 μm; the layer thicknesses of the coatings can be found in Tables 1 to 3.

Typical application conditions were as follows:
web speed 1.3 to 2.0 m/min
wet coating material applied 20-150 μm
air circulation dryer 90-110° C., preferably in the region of the TG of the polymer to be dried.
residence time in the dryer 3.5-5 min.

The coating was effected roll to roll, meaning that the polycarbonate film was unrolled in the coating system. The film was conducted through one of the abovementioned application units and contacted with the coating solution. Thereafter, the film with the wet coating was run through the dryer. After leaving the dryer, the now dry coating was provided with a lamination film, in order to protect it from soiling and scratching. Thereafter, the film was rolled up again.

For the testing of the final properties of the product, the coated film, after leaving the dryer, can first be cured with a UV lamp and then provided with a laminating film.

### Example 4

### Blocking Resistance

The coated side of the non-UV-cured films produced in Example 3 is covered with a laminating film of the GH-X 173 A type (Bischof+Klein, Lengerich, Germany) and weighted down with an aluminium sheet of dimensions 4.5×4.5 cm² and a weight of 2 kg at about 23° C. for 1 h. After the said hour, the weight and the lamination film are removed and the surface of the coating is checked visually for changes.

The experiments show that the coatings are blocking-resistant (no indentation in the film) from a molecular weight of the polymethylmethacrylate of 100 000 or more.

### Example 5

### Forming Tests

The HPF forming tests were performed on an SAMK 360 system from Niebling (Germany). The mould was electrically heated to 100° C. The film heating was undertaken by means of IR emitters at 240-260-280° C. The heating time was 16 seconds. A film temperature of about 170° C. was attained. The forming was effected at a forming pressure of 100 bar. The forming mould was a heating/ventilation panel (HV panel).

The film sheet was fixed at an exact position on a pallet. The pallet passed through the forming station into the heating zone and resided therein for the time set (16 s). In the course of this, the film was heated in such a way that the film briefly experienced a temperature above the softening point; the core of the film was about 10-20° C. colder. As a result, the film was relatively stable when it was run into the forming station.

In the forming station, the film was fixed by closing the mould over the actual mould; at the same time, the film was formed over the mould by means of gas pressure. The pressure hold time of 7 seconds ensured that the film was accurately formed by the mould. After the hold time, the gas pressure was released again. The mould opened and the formed film was run out of the forming station.

The film was subsequently removed from the pallet and could then be cured with UV light.

With the mould used, radii down to 1 mm were formed.

The UV curing of the inventive coating was executed with an evo 7 dr high-pressure mercury lamp (sar engineering GmbH, Lippstadt, Germany). The system was equipped with dichroitic reflectors and quartz discs and has a specific power of 160 W/cm. A UV dose of 2.0 J/cm² and an intensity of 1.4 W/cm² were applied. The surface temperature was to reach >60° C.

The UV dose figures were determined with a Lightbug ILT 490. (International Light Technologies Inc., Peabody Mass., USA). The surface temperature figures were determined with temperature test strips of the RS brand (catalogue number 285-936; RS Components GmbH, Bad Hersfeld, Germany).

Results for the durability of the coatings which have been crosslinked using the conditions specified can be found in Table 1.

TABLE 1

| | | | | | | Steel wool |
|---|---|---|---|---|---|---|
| | | | | | Pencil | (from Rakso, |
| | | Thickness | | Solvent | hardness | No. 00) |
| | | of the | | IP/MPA/X/EA/Ac | 500 g | 560 g/10 DH |
| No. | Coating | paint film | Backing film | 1 h/RT | Mitsubishi | ΔG/ΔH |
| 1 | Example 1 | 5 μm | Makrofol DE | 0/0/0/0/0 | HB | |
| | | | 1-1 | | | |
| 2 | Example 1 | 8 μm | Makrofol DE | 0/0/0/0/0 | HB | |
| | | | 1-1 | | | |
| 3 | Example 1 | 12 μm | Makrofol DE | 0/0/0/0/0 | HB | |
| | | | 1-1 | | | |
| 4 | Example 1 | 17 μm | Makrofol DE | 0/0/0/0/0 | H | 5/5 |
| | | | 1-1 | | | |
| 5 | Example 1 | 25 μm | Makrofol DE | 0/0/0/0/0 | H | |
| | | | 1-1 | | | |
| 6 | uncoated | — | Makrofol DE | 0/5/5/5/5 | 3B | 100/285 |
| | | | 1-1 | | | |

Table 1 shows that the inventive coating achieved an improvement in pencil hardness and scratch resistance. The coating led to a very good solvent resistance of the films. Particularly notable was the solvent resistance of the coated film to acetone. Acetone, the most aggressive solvent for coated polycarbonate, as obtainable, for example, under the Makrofol brand (Bayer), has almost no effect on the inventive final coating, even with a contact time of 1 hour (rating≦1; scoring 0 to 5). This means that the solvent resistance for this coating is at the level of the best (but non-formable) hardcoat coatings according to the prior art.

### Example 6

### Production of Test Specimens and Testing of Impact Resistance (Low-Temperature Toughness)

For the analysis of impact resistance, specimens were produced by insert-moulding flat polycarbonate films, coated in accordance with the invention, of Makrofol DE 1-1 (250 &m) as per numbers 1 to 6 in A5 format with polycarbonate, from the uncoated side. The insert moulding was effected on an Arburg Allrounder 560 C 2000-675/350 injection moulding machine. The machine had a screw diameter of 45 mm. The Makrolon was insert-moulded at a melt temperature of 280° C. The fill time for filling of the mould was 2 sec. The mould temperature was varied. It was possible to achieve good results with a mould temperature of 80° C. and 100° C. There was no visually apparent adverse effect in this regard. The hold pressure time was 12 sec and the cooling time was 20 sec. The polycarbonate used was Makrolon AL 2647 (Bayer MaterialScience AG). The layer thickness of the polycarbonate applied was 4 mm. 60×60 mm² test specimens were sawn out of the polycarbonate film layer specimens obtained in this way.

The sheet puncture test was conducted on the basis of DIN EN ISO 6603-1 with falling mass 13 kg at various impact speeds with an instrumented drop system from RoellAmsler (IFW 420) at −30° C. Spike diameter 20 mm, contact surface diameter 40 mm. The impact speed was varied to determine the ductile/brittle transition.

The nature of the fracture (ductile/brittle fracture) was determined on the basis of the appearance of the fracture in the impacted test specimens: A ductile fracture was considered to be either a plastic deformation without cracking (as per the standard) or (in a departure from the standard) a puncture of the specimen if it remained in one piece. Brittle fracture was regarded as the breakup of the sample into two or more pieces.

The results of these tests are compiled in Tables 2 and 3.

TABLE 2
Puncture test (−30° C.): Tensile zone—inventive paint film; impact on the PC side

| | | | | | | Critical speed |
|---|---|---|---|---|---|---|
| | | Thickness | | Ductile fracture | Brittle | at the ductile/ |
| | Coating | of the | | observed at | fracture at | brittle transition |
| No. | material | paint film | Backing film | [m/s] | [m/s] | [m/s] |
| 1 | Example 1 | 5 μm | Makrofol DE | 8.0/9.9/12.2 | — | >12.2 |
| | | | 1-1 | | | |
| 2 | Example 1 | 8 μm | Makrofol DE | 9.3/10.6/11.2 | 12.2 | 12.7 ± 0.5 |
| | | | 1-1 | | | |
| 3 | Example 1 | 12 μm | Makrofol DE | 3.6/4.0/5.4 | 5.0/6.6 | 5.2 ± 0.2 |
| | | | 1-1 | | | |
| 4 | Example 1 | 17 μm | Makrofol DE | 2.9/3.6 | 4.0/4.9/6.5 | 3.8 ± 0.2 |
| | | | 1-1 | | | |
| 5 | Example 1 | 25 μm | Makrofol DE | — | 2.2/3.2/4.9 | <2.2 |
| | | | 1-1 | | | |

TABLE 3
Puncture test (−30° C.): Tensile zone—Makrolon AL 2647; impact on the coated side

| | | | | | | Critical speed |
|---|---|---|---|---|---|---|
| | | Thickness | | Ductile fracture | Brittle | at the ductile/ |
| | Coating | of the | | observed at | fracture at | brittle transition |
| No. | material | paint film | Backing film | [m/s] | [m/s] | [m/s] |
| 1 | Example 1 | 5 μm | Makrofol DE | 8.1/10.0/12.0 | — | >12.0 |
| | | | 1-1 | | | |
| 2 | Example 1 | 8 μm | Makrofol DE | 8.0./9.3/12.3 | — | >12.3 |
| | | | 1-1 | | | |
| 3 | Example 1 | 12 μm | Makrofol DE | 6.6/9.2/12.2 | — | >12.2 |
| | | | 1-1 | | | |
| 4 | Example 1 | 17 μm | Makrofol DE | 8.0/9.3/12.2 | — | >12.2 |
| | | | 1-1 | | | |
| 5 | Example 1 | 25 μm | Makrofol DE | 8.0/9.2/12.2 | — | >12.2 |
| | | | 1-1 | | | |

When the impact comes from the painted side (Table 3), all the test specimens show a ductile appearance, which does not show any embrittlement of the polycarbonate by the inventive coatings having thickness between 5 and 25 μm.

An equal high-toughness level is also exhibited by the test specimens having the inventive coating in a thickness of 5 μm. In the case of the thicker paint applications, brittle fracture can be caused, but the critical speeds for this are above the level of 2.0 m/s for coatings up to 17 μm. Only in the case of the coating of 25 m does the critical speed fall below this limit, which is set as the lower limit for toughness characteristics adequate for application purposes.

This means that plastics parts produced by the process described here, irrespective of the direction of impact, have a low-temperature toughness sufficient for typical applications when the layer thickness of the coating of the film does not exceed 20 μm.

The inventive mouldings thus have excellent non-directional impact resistance even at low temperatures, combined with simultaneous exceptional scratch resistance and solvent resistance of the surface. This combination of properties means that they are of excellent suitability for the production of plastics parts for automobiles, aircraft, rail vehicles, electronic articles, and indoor and outdoor architecture. More particularly, the inventive mouldings are suitable for use as transparent sheets in the architectural, automotive, aviation and rail sectors.

1.-15. (canceled)

16. A coating composition comprising
(a) at least one thermoplastic polymer having a mean molar mass of at least 100 000 g/mol in a content of at least 30% by weight of the solids content of the coating composition;
(b) at least 30% by weight of a UV-curable reactive diluent;
(c) 0.1 to 10 parts by weight of at least one photoinitiator; and
(d) at least one organic solvent,
wherein the proportion of ethylenically unsaturated groups is at least 3 mol per kg of the solids content of the coating composition.

17. The coating composition as claimed in claim 16, wherein the thermoplastic polymer (a) has a Vicat softening temperature VET to ISO 306 of at least 90° C.

18. The coating composition as claimed in claim 16, wherein the thermoplastic polymer comprises polymethylmethacrylate or copolymers of 70% by weight to 99.5% by weight of methyl methacrylate and 0.5% by weight to 30% by weight of methyl acrylate.

19. The coating composition as claimed in claim 16, wherein the at least one UV-curable reactive diluent (b) comprises bifunctional, trifunctional, tetrafunctional, pentafunctional and/or hexafunctional acrylic and/or methacrylic monomers.

20. The coating composition as claimed in claim 16, wherein the reactive diluent (b) comprises alkoxylated diacrylates and/or dimethacrylates, alkoxylated triacrylates and/or trimethacrylates, alkoxylated tetraacrylates and/or tetramethacrylates, alkoxylated pentaacrylates and/or pentamethacrylates, alkoxylated hexaacrylates and/or hexamethacrylates, aliphatic urethane acrylates, polyester acrylates, polyacryloylacrylates and mixtures thereof.

21. The coating composition as claimed in claim 16, wherein the reactive diluent (b) comprises dipentaerythrityl penta-/hexaacrylate.

22. A non-directionally impact-resistant 3D moulding comprising a thermoplastic polymer, a film of a thermoplastic polymer and a scratch-resistant and solvent-resistant surface coating of the film, said surface coating forming the surface of the moulding and having a thickness in the range from ≧0.1 μm to ≦20 μm, obtained by coating a surface of the film with a coating composition as claimed in claim 16.

23. The moulding as claimed in claim 22, obtained by film insert moulding, wherein the film insert moulding comprises the filling of a 3D-formed film comprising the protective layer with the melt of a thermoplastic polymer on the side of the film remote from the protective layer.

24. The moulding as claimed in claim 22, wherein the film comprises polycarbonate.

25. The moulding as claimed in claim 22, wherein the thermoplastic polymer comprises polycarbonate.

26. A film insert moulding process for production of a moulding, comprising the steps of
(i) coating a surface of a film with a moulding composition comprising
(a) at least one linear thermoplastic polymer having a mean molar mass of at least 100 000 g/mol in a content of 30% by weight of the solids content of the coating composition;
(b) at least 30% by weight of a UV-curable reactive diluent;
(c) 0.1 to 10 parts by weight of at least one photoinitiator; and
(d) at least one organic solvent,
wherein the proportion of ethylenically unsaturated groups is at least 3 mol per kg of the solids content of the coating composition and the thickness of the coating is in the range from ≧0.1 μm to ≦20 μm,
(ii) drying the coating;
(iii) optionally cutting the film to size, delaminating, printing and/or thermally or mechanically forming the film;
(iv) curing the coating by means of actinic radiation, preferably UV radiation;
(v) insert-moulding the uncoated surface of the film with a thermoplastic polymer.

27. The process as claimed in claim 26, wherein the insert moulding (V) is effected by means of extrusion or injection moulding.

28. A product comprising the moulding as claimed in claim 22.

29. The product as claimed in claim 28, wherein the product is a transparent glazing element, cover or viewing window from the fields of architecture, automobile construction, rail vehicle construction, aircraft construction, the manufacture of visors for protective helmets and the production of electronic products or of transparent, semitransparent or nontransparent parts of interior trim or exterior trim of automobiles, rail vehicles or aircraft.

30. An architectural glazing element, automobile glazing element, rail vehicle glazing element, water vehicle glazing element, aircraft glazing element, bodywork facing component, windshield, helmet visor, electronics housing component, or interior or exterior trim component of automobiles, rail vehicles, water vehicles or aircraft comprising the moulding as claimed in claim 22.
